(19) United States
(12) Patent Application Publication
(10) Pub. No.: US 2023/0135205 A1
(43) Pub. Date: May 4, 2023

(54) SECURE TRACKING AND MANAGEMENT OF COMMERCIAL AIR TRAVEL FACILITIES

(71) Applicant: Kenton County Airport Board, Erlanger, KY (US)

(72) Inventors: Brian Cobb, Union, KY (US); Stephen Saunders, Union, KY (US)

(21) Appl. No.: 17/949,039

(22) Filed: Sep. 20, 2022

Related U.S. Application Data
(60) Provisional application No. 63/272,748, filed on Oct. 28, 2021.

(51) Int. Cl. G08G 5/00; B64F 1/36; G06Q 10/02

(52) U.S. Cl. CPC G08G 5/003; B64F 1/366; G06Q 10/02

(57) ABSTRACT

A system is configured to receive boarding pass data or other passenger data from passengers as they arrive at an airport. Data is received at a scanner or other location, and private or irrelevant data is redacted by a secure device at that location before a redacted dataset is provided to an airport management server (AMS). The secure device includes various security features to prevent intentional or accidental misuse of received data, including secure data connections and software processes. Real-time passenger data is combined with historic passenger data and data from other sources (e.g., local weather, local traffic, door traffic sensors) to profile passenger characteristics and generate passenger arrival predictions for upcoming time periods. Predictions and related information may be visualized and displayed via a dashboard, which may also include controls for providing messaging and management of systems and devices.

### PRIORITY

This application claims priority to U.S. Provisional Patent application 63/272,748, filed Oct. 28, 2021, titled “SECURE TRACKING AND MANAGEMENT OF COMMERCIAL AIR TRAVEL FACILITIES,” the entire disclosure of which is hereby incorporated by reference herein.

### FIELD

The disclosed technology pertains to a system for securely tracking and managing aspects and facilities related to commercial air travel.

### BACKGROUND

While the most obvious and critical aspect of a commercial airport is the movement of passengers and cargo to various destinations, that simple concept doesn't capture the true scope and complexity of the technology and processes that enable an airport to function. While different technologies and systems are used in airports, such as for air traffic control processes, or providing flight status updates to passengers, such conventional technologies are isolated, function specific, and tend to be reactive rather than proactive. As an example, an individual commercial airline's reservation system can readily analyze available passenger records to determine how many tickets have been issued to passengers for flights in a given day, and how many actual passengers have boarded each flight. However, commercial, domestic airports do not receive this information, nor is it provided by airlines in any significant detail or on a routine basis out of competitive concerns. Airports have no consistent means of knowing how many passengers depart on a given date at any given time. Depending on airport billing practices, airlines will provide a month-end aggregate number of departing or arriving passengers to airports for invoicing.

While information on actual flights compared to actual passengers boarded has some value, the uses and value tend to be reactive (e.g., identifying a problem or issue that has occurred, rather than anticipating and mitigating a problem before or as it arises). As an example, a conventional approach to airport management might include reviewing the number of passenger boardings each day (e.g., should they be made available across all airlines), and then making resource, personnel, and facility decisions. However, since this approach is reactionary to a day's aggregate boardings, it would not support any meaningful real-time data analysis, by airline, by flight, or for significant multiple impacted flight events (e.g., weather) or historic information patterns (e.g., holiday travel).

As one example, while a single issued ticket indicates that one passenger is likely to fly out of the airport, it does not indicate whether that passenger will arrive at the airport by taxi, drive themselves and park in long-term parking, arrive with a group that will park in guest parking and wait with until the passenger's flight leaves, or other operationally supportive detail. As a result, a staffing or resource decision based solely on issued tickets results in insufficient and or inconsistent availability of the same (e.g., a high volume of unanticipated non-flying guests arriving with passengers may overwhelm staff at information desks or other services). The most common visible result to traveling customers are waiting queues, otherwise known as standing in lines.

As another example, a number of issued tickets for a particular period of time does not account for any historic patterns associated with the same or similar period of time (e.g., week to week, month to month, year to year, and so on). As an example, this may include weekly patterns relating to peak flight times for business travel and leisure travel. Business travelers are more likely to miss a flight, or more likely to arrive at the airport later than the recommended time given their familiarity with travel processes. Leisure travelers, on the other hand, are more likely to fly as scheduled and arrive at the airport much earlier giving ample time to park their vehicle, check luggage, process through security, and possibly shop or dine prior to their flight's departure. Resource scheduling decisions today are made in the absence of such information and may result in deployed resources being underutilized during peak business travel times and days, and being overwhelmed during peak personal travel times and days.

While many of the limitations of conventional airport management technology are unintentional, others may be somewhat intentional and based on concerns around data privacy of passengers and others, and on security more generally (e.g., data security, network security, facility security). While isolation of certain systems and functions is limiting and can result in inefficient allocation of resources, there is a significant security benefit (e.g., each additional device within a shared technology ecosystem presents additional risk of intrusion or compromise). As a highly regulated industry with major concerns around the security of passenger privacy, passenger data, and airport data, the result is that conventional technology and approaches to airport management are largely manual, and performed by personnel based upon their own experience and isolated datasets from disparate and unconnected ecosystems. While such approaches may not be impactful in small airports, they become more substantial as the size and complexity of operations at an airport increases. With some airports approaching the size and complexity of a city (e.g., a major United States airport has facilities spread across 85 square miles, while one international airport's facilities span more than 300 square miles), this type of isolated decision making and resource allocation can have a huge negative impact on the experience and safety of passengers and personnel alike.

What is needed, therefore, is a system for accessing existing passenger data via secure network standards and sharing the non-personally identifiable information to provide and improve airport situational awareness and resource allocations based on real-time passenger activity, with capacity to understand historical trends and predictive scenarios.

### BRIEF DESCRIPTION OF THE DRAWINGS

The drawings and detailed description that follow are intended to be merely illustrative and are not intended to limit the scope of the invention as contemplated by the inventors.

FIG. 1 is a schematic diagram of an exemplary system configured to securely track and manage aspects of an airport.

FIG. 2 is a high level flowchart illustrating exemplary activities of the system of FIG. 1.

FIG. 3 is a schematic diagram of an exemplary redaction interface usable with the system of FIG. 1.

FIG. 4 is a flowchart showing an exemplary set of steps that may be performed to securely receive and provide passenger data to the system of FIG. 1.

FIG. 5A is an illustration of an exemplary boarding pass.

FIG. 5B is a diagram showing exemplary information parsed from the boarding pass of FIG. 5A.

FIG. 5C is a diagram showing exemplary the information of FIG. 5B after redaction.

FIG. 6 is a flowchart showing an exemplary set of steps that may be performed to track and manage arrival of guests at an airport.

FIG. 7 is a flowchart showing an exemplary set of steps that may be performed to manage variances in guest arrival.

FIG. 8 is a flowchart showing an exemplary set of steps that may be performed to manage variances in passenger arrival.

FIG. 9 is a screenshot of an exemplary management interface provided by the system of FIG. 1.

FIG. 10A is a screenshot of an exemplary arrival timeline provided by the system of FIG. 1.

FIG. 10B is a screenshot of an exemplary runway heatmap provided by the system of FIG. 1.

FIG. 10C is a screenshot of an exemplary facility heatmap provided by the system of FIG. 1.

### DETAILED DESCRIPTION

The inventors have conceived of novel technology that, for the purpose of illustration, is disclosed herein as applied in the context of secure airport management. While the disclosed applications of the inventors' technology satisfy a long-felt but unmet need in the art of secure airport management, it should be understood that the inventors' technology is not limited to being implemented in the precise manners set forth herein, but could be implemented in other manners without undue experimentation by those of ordinary skill in the art in light of this disclosure. Accordingly, the examples set forth herein should be understood as being illustrative only, and should not be treated as limiting.

Information systems in the commercial aviation industry are highly regulated, both due to regulatory requirements and other laws, but also due to the self-imposed standards of what is common and reasonable for the industry. Security concerns around aviation are numerous, and include concerns around the physical security of individual flights, the data security of the wealth of passenger information stored by participants in the industry, and the critical nature of uninterrupted commercial flight for a stable and functioning economy. As a result, basic information security principles and practices that are sufficient in other industries may be insufficient when implemented within the air travel industry. Over time this has caused the technologies used in the aviation industry to evolve slowly. While interconnectivity and availability of information is generally considered to be desirable, technology in the aviation industry has instead focused on isolated purpose specific systems that operate with little or no context or visibility of other systems.

Implementations of the technology and systems disclosed herein provide flexible and broad interconnectivity for aviation technology without compromising the security of existing systems. As will be described in more detail below, various aspects of the disclosed system would conventionally be considered undesirable or disadvantageous in many industries. However, within the field of aviation technology they represent a major improvement that provides numerous advantages and, perhaps more importantly, is feasible within the rigid security framework that participants in the aviation industry operate within.

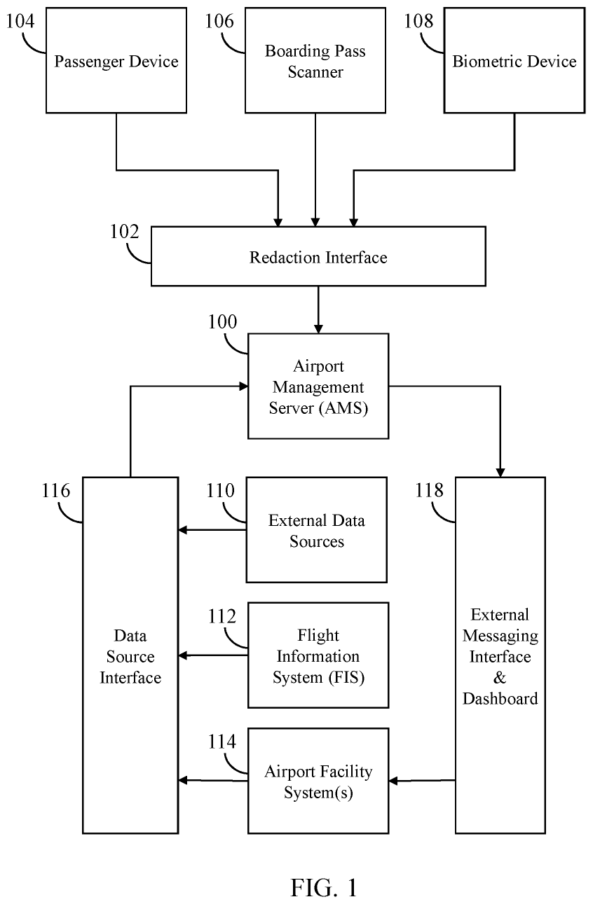

Turning now to the figures, FIG. 1 is a schematic diagram of an exemplary system configured to securely track and manage aspects of an airport. An airport management server (“AMS”) (100) is configured to receive, store, and analyze data passing through the system, and may include one or more servers or server environments including physical servers, virtual servers, cloud servers, or other environments, with each server having or having the use of components such as processors, memories, storage devices, communication devices, and other components as may be required to receive, transmit, store, analyze, and modify data over a network. In some implementations, the AMS (100) may be remotely located from an airport that it is configured to serve, and may be isolated from other systems and devices within that airport. Such isolation may include physical separation (e.g., being located offsite, not sharing any common hardware infrastructure), network isolation (e.g., being on a separate and distinct communication network), and other configurations and characteristics that prevent bi-directional communication or interactions between the AMS (100) and other systems.

The AMS (100) may be configured to provide interfaces allowing limited communication with other device and systems, which may include a redaction interface (102), a data source interface (116), and an external messaging and dashboard interface (118). As will be described in more detail below, the redaction interface (102) may include software and devices configured to receive passenger information from various sources, redact and sanitize the received information, and provide sanitized information to the AMS (100) while ensuring that no remnant of the initially received data remains outside the AMS (100).

Passenger information sources may include, for example, passenger devices (104), boarding pass scanners (106), biometric devices (108), and other devices that passengers interact with in order to provide passenger information, flight information, or otherwise enable the travel process. Passenger devices may include smartphones, tablets, or other user devices that may be configured with software that provides details on a passenger (e.g., a virtual boarding pass application or other software application that is used to aid a passenger in the travel process). Boarding pass scanners (106) may include optical scanners that are configured to read information from a printed or electronically displayed boarding pass, and which may be positioned at various locations around an airport facility. One example of a boarding pass scanner (106) is the DESKO PENTA Scanner® BGR, offered by DESKO GmbH.

The boarding pass scanner (106) may capture and interpret encoded information from a boarding pass (e.g., flight, departing airport, destination airport, seat, fare class, departing time, departing date, as well as identifying information such as a name or identifier number, with information being interpreted in plaintext form, encoded forms, or both), and in conventional use, scanners such as the scanner (106) may be positioned at a security checkpoint where passengers and carryon baggage are screened, as well as at the gate where a passenger boards their airplane. Due to their presence and use in some of the most critical and highly secure aspects of air travel, such scanner devices are incapable of direct communication with the AMS (100). The boarding pass scanner (106) may be the same device or a similar device as such scanners, but may be flexibly positioned about an airport facility as may be desirable for a particular implementation. For example, in some cases the boarding pass scanner (106) may be positioned proximate to another scanner that is not part of the disclosed system, may be positioned at doorways or in hallways that guests travel through, may be positioned near stores, restrooms, or in waiting lines where guests may be waiting, or may be positioned in other areas where guests are likely to interact with the boarding pass scanner (106).

The biometric devices (108) may be configured to provide a same or similar function as the boarding pass scanner (106), in particular, identifying a particular passenger and a flight or set of flight information that a particular passenger is associated with. Biometric devices (108) may include, for example, imaging devices, audio capture devices, or other sensors capable of uniquely identifying a person based on biometric characteristics such as a fingerprint, handprint, facial image, or voice sample. While there are numerous concerns with biometric devices (108) relating to individual privacy, they can be configured to operate with a very high degree of security since the pre-configured biometric data used to match against individuals may be encoded and stored in proprietary and secure forms (e.g., rather than storing an image of a face, the device may store machine data that encodes key structural aspects of the face image). Once positively identified, the biometric device (108) may provide unique information linking the identity to a set of information similar to that associated with a boarding pass (e.g., flight number, departure time, etc.).

In each case, where included in a particular implementation of the system, the redaction interface (102) may be configured to communicate with the source device (104, 106, 108) securely, which may include hardwired connectivity (e.g., device to device USB or other data connection, which may include each device verifying identity of the other during communication), and is configured to redact and sanitize and received data to ensure that no readily identifiable data is provided to the AMS (100) or others components of the system. For example, information that may be provided from a source (104, 106, 108) may include a passenger's first name, last name, or other information that may be used to independently identify the passenger, as well as sensitive information such as date of birth, social security number, unique customer number, or the like. In such cases, the redaction interface (102) may be configured to redact any information that directly identifies the passenger, or that is sensitive information while having little value to the features provided by the AMS (100), so that the only remaining information is both relevant and not readily usable to identify the passenger. As will be described in more detail below, this information may be redacted in real time, as it is received, to ensure that it is not stored on or accessible on the redaction interface (102) or provided to the AMS (100).

Information received via the redaction interface (102) will vary by implementation, but may generally include basic flight information such as flight number, departing time, arrival time, flight date, destination, ticket class, seat number, and other information that may be suggestive of characteristics or a profile of the passenger, without readily identifying the passenger themselves. For example, information such as the above might indicate that the passenger has arrived at the airport several hours before their flight departs (e.g., business flyers tend to arrive just before a flight, where personal flyers arrive much earlier), and that the destination is a popular location for leisure trips but rarely associated with business trips, which the AMS (100) may use to determine that the passenger is flying on a personal trip.

Such profiling information may be used to predict the arrival of other passengers having similar profiles or shared characteristics. Such information may be collected over time and has value in predicting the flow of arrival traffic to the airport in the future, which may provide actionable insights for management of the airport relating to parking, ground traffic control at airport entrances, security screening queues and wait times, and use, availability, and maintenance needs of other facilities within the airport such as vendors (stores, restaurants), restrooms, help desks, staff, and other resources.

This data becomes even more accurate and valuable when combined with other data points. To this end, the AMS (100) may provide a data source interface (116) that is configured to receive information from other systems, sources, and devices. Examples of such sources will vary by implementation, but may include external data sources (110) (e.g., third party data sources that provide information via an API, which may include local weather information, local traffic information, passenger information from rideshare or mass transit systems, and other relevant information), an airport flight information system (“FIS”) (112) (e.g., one or more systems that store data related to passengers and flights), and other airport facility systems (114) (e.g., information systems and devices related to parking, fire, weather, and other emergency detection and alert systems, personnel management systems, third party systems operated by vendors within the airport, etc.).

Communication between the data source interface (116) and the sources (110, 112, 114) may be configured to maintain the security and isolation of those systems, which may include configuring the flow of information to be unidirectional, such as where the FIS (112) is configured to regularly push selective information to the data source interface (116), without receiving a request for the information, a confirmation of receipt, or otherwise.

The AMS (100) may also provide an external messaging interface (118), which may be configured to provide human triggered and/or automated messaging from the AMS (100). Messaging provided via the messaging interface (118) may include text electronic text communications to various recipients, may include programming messaging that is configured to cause recipient devices or systems to take some action, and may also include graphical user interfaces that may be accessed via software applications or websites such as an airport status dashboard.

As shown in FIG. 1, the messaging interface (118) is not in communication with the FIS (112), preserving the security of that system. Instead, the messaging interface (118) may be in communication with one or more other airport facility systems (114). In this manner, the AMS (100) may, based upon analyzing current and historic information, predict a large influx of passengers and other guests arriving at the airport over the next hour, and may notify a system that manages the electronic messaging around the roadways and paths leading to the airport to cause that system to provide an updated set of electronic messaging (e.g., expected wait times, instructions related to parking, dropping off passengers, or entering the terminal, etc.).

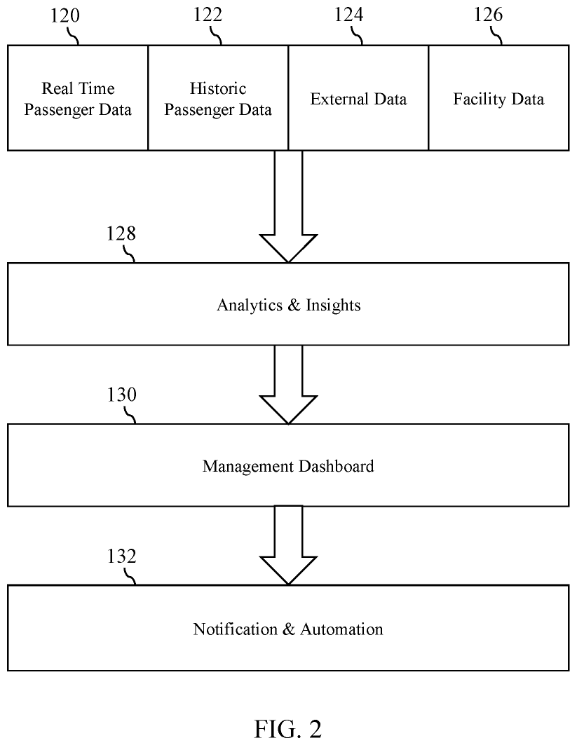

FIG. 2 is a high level flowchart that summarizes several of the above described features of the system of FIG. 1. The system (e.g., the AMS (100)) receives real time passenger data (120) as those passengers arrive at various locations of the airport (e.g., via boarding pass scanners (106) and the redaction interface (102)). The real time passenger data (120) doesn't identify particular passengers, but does identify characteristics of passenger profiles more generally. The real time passenger data (120) may be combined with historic passenger data (122), and may be examined to provide analytics and insights (128). The historic passenger data (122) may include both previously received real time passenger data (120), as well as passenger data from the FIS (112). Data received from the FIS (112) may include information such as the total number of boarding passes issued over a period of time, as well as the total number of boarding passes that were actually used to board a plane over the same period of time.

The generation of analytics and insights (128) may be performed on received data using pre-configured rules, expert modules, machine learning processes, genetic algorithms, or other artificial intelligence processes. This analysis (128) may also consider additional data such as external data (124) from third party sources, including weather data, traffic data, local event data, and other information that may influence the arrival time of passengers or guests. This analysis (128) may also consider facility data (124) from other systems within the airport, such as information related to parking availability, vendors (e.g., restaurants and shops in an around the terminal), personnel, and other information.

The created analytics and insights (128) may include data visualizations (e.g., graphs, timelines, heat maps), data tables, and other user-facing output, and may also include automated notifications and messaging. User-facing output may be provided to users via a management dashboard (130), which may be provided via, for example, a software application, web application or website, or other user interface. The management dashboard (130) may provide various outputs from the analytics and insights (128), and may also provide users controls for viewing, confirming, or providing notifications and other automated messaging generated by the analytics and insights (128).

Generated notifications and automation (132), whether occurring entirely automatically or being triggered or confirmed via the management dashboard (130), may include user oriented electronic notifications (e.g., text messages, email, computer generated voice announcements) as well as programmatic messaging that is sent to other systems and configured to cause those systems to take automated actions (e.g., to the extent that the recipient system is also configured to receive and act upon the message, which may include validation of the message and its origin). For security purposes, messages received by any recipient may be acted upon or disregarded, and so messages arriving in this manner (e.g., via the external messaging interface (118)) may be by way of a messaging queue or other asynchronous communication rather than an API or other more direct interface.

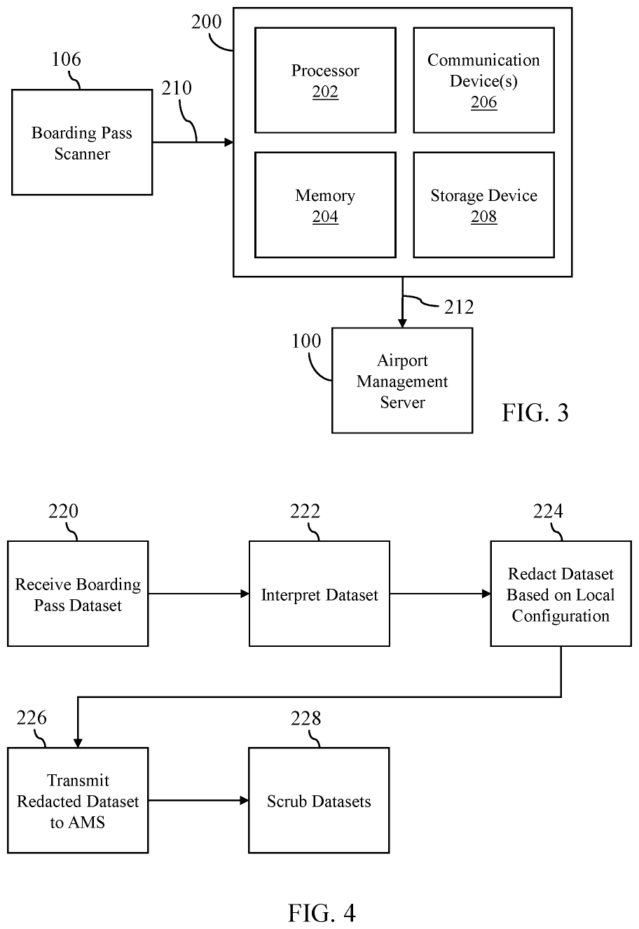

While the redaction interface (102) described above may take varying forms depending upon the particular source of data (104, 106, 108), FIG. 3 shows one example of a redaction interface (200) that is appropriate for use with the boarding pass scanner (106). The redaction interface (200) may be implemented as a single board computer (SBC) or other computing device having a processor (202), memory (204), one or more communication devices (206), and a storage device (208) for non-volatile storage. The redaction interface (200) may be positioned proximate to the boarding pass scanner (104) and coupled to that device via a hardwired connection (210) such as USB, Ethernet, or the like. The boarding pass scanner (104) may not include any communication interface other than that used for the hardwired connection (210), and each device may perform local validation of communication across that hardwired connection (210) based upon pre-configured settings (e.g., MAC address recognition, serial number recognition, and ping time of travel verification). The hardwired connection (210) may also be configured for unidirectional communication from the scanner (106) to the redaction device (200).

The redaction device (200) may be in communication with the AMS (100) via a server connection (212), which may be a wired or wireless connection (e.g., Wi-Fi, cellular data). While there is a possibility that some private data may be flowing from the boarding pass scanner (106) to the redaction device (200), any data flowing on to the AMS (100) will already be redacted and sanitized and so the server connection (212) may be more flexible than the hardwired connection (210).

In some implementations, the redaction device (200) may be configured to minimize the time that any data received from the scanner (106) is handled or processed, and may also be configured to minimize the opportunity for such data to be stored on the redaction device (200) after processing. This may include configuring the storage device (208) to store any necessary software or other settings for basic functionality in a read-only mode, such that subsequent attempts to write data to the storage device (208) (e.g., as part of caching or paging operations, or by a bad actor) will fail. This may also include excluding the non-volatile storage device (208), and storing all required software and configurations in the memory and/or processor (e.g., any required software may be received from a remote source when the device is powered on, and stored and executed in the memory (204) until the device loses power), such that the device is assured to not contain any private data if it is removed from the system by a bad actor or other party.

In addition to hardware implemented security features, the redaction interface (102) may also include software implemented security features and configurations. As an example, FIG. 4 is a flowchart showing an exemplary set of steps that may be performed to securely receive and provide passenger data to the AMS (100), such as may be performed with a redaction interface (102, 200). A boarding pass dataset or other passenger dataset may be received (220) from a source (104, 106, 108) and may be briefly stored in memory. The boarding pass dataset may be interpreted (222), which may include, for example, interpreting optical image data into a string value, may include decoding or interpreting values from a string value, or both.

The interpreted dataset may then be redacted (224) or otherwise sanitized based upon a set of configurations or redaction rules stored locally to the redaction interface. These redaction rules may be statically configured to block data within a string or array based upon location (e.g., where the first 20 positions of a string value will always contain the passenger's first and last name, the first 20 positions will be removed or overwritten), or based upon analysis of the content (e.g., where a semantic analysis, pattern analysis, or other content-based analysis indicates that the first 20 positions of a string value contain a first and last name, these positions may be removed or overwritten). This redaction (224) may be performed on data stored in memory and may be prioritized to occur immediately after the data becomes available, such that any private data is only stored in memory, and only for computational time periods (e.g., nanoseconds). In some implementations, this redaction (224) step may be performed by a logic board integrated with the hardwired connection (210), such that the data is already redacted before it is even received by the memory (204) of the redaction device (200).

Once the sanitized dataset is available, it may be transmitted (226) to the AMS (100) and any traces of any related datasets may be scrubbed (228) from the redaction interface. In some implementations, this may include clearing or overwriting associated portions of the memory (204) or storage device (208), including any caches of the communication devices (206) or other components that might store any part of any dataset. While the example of FIG. 3 and FIG. 4 reference the boarding pass scanner (106) specifically, the teachings may also be applied to other passenger data sources. For example, where the passenger device (104) is configured to provide a virtual boarding pass via Bluetooth, NFC, or other proximate wireless transmission, or via Wi-Fi, a corresponding redaction interface (102) may similarly receive, interpret, and redact any unnecessary data.

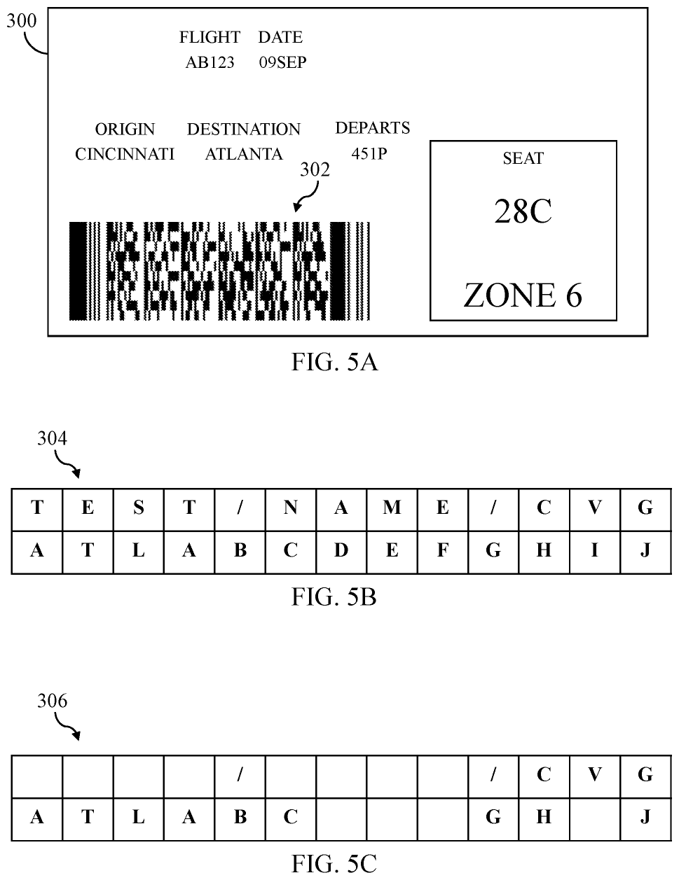

As a related example, FIG. 5A illustrates a boarding pass (300) that includes various printed information related to a corresponding flight, as well as a machine readable code (302) that may include some or all of the printed information, as well as additional information. FIG. 5B is a diagram illustrating a 26 position string (304) or array such as may result from scanning the machine readable code (302) with a boarding pass scanner (106). Positions 1-10 include the passengers name, positions 11-16 include information on the flight origin and destination, while positions 17-26 include variables whose meaning can only be determined within additional context or data (e.g., the position 17 may indicate whether the ticket is first class or economy class, where the character “A” indicates first class and “B” indicates economy). FIG. 5C is a diagram illustrating the string (304) of FIG. 5B as a redacted string (306), after the performance of steps such as those of FIG. 4. As can be seen, in the redacted string (306) the private data in positions 1-10 has been removed, in addition to several of the variables in positions 17-26 that are irrelevant, indicate private data, or both. The redacted string (306) may be provided to the AMS (100) without concerns for security or privacy.

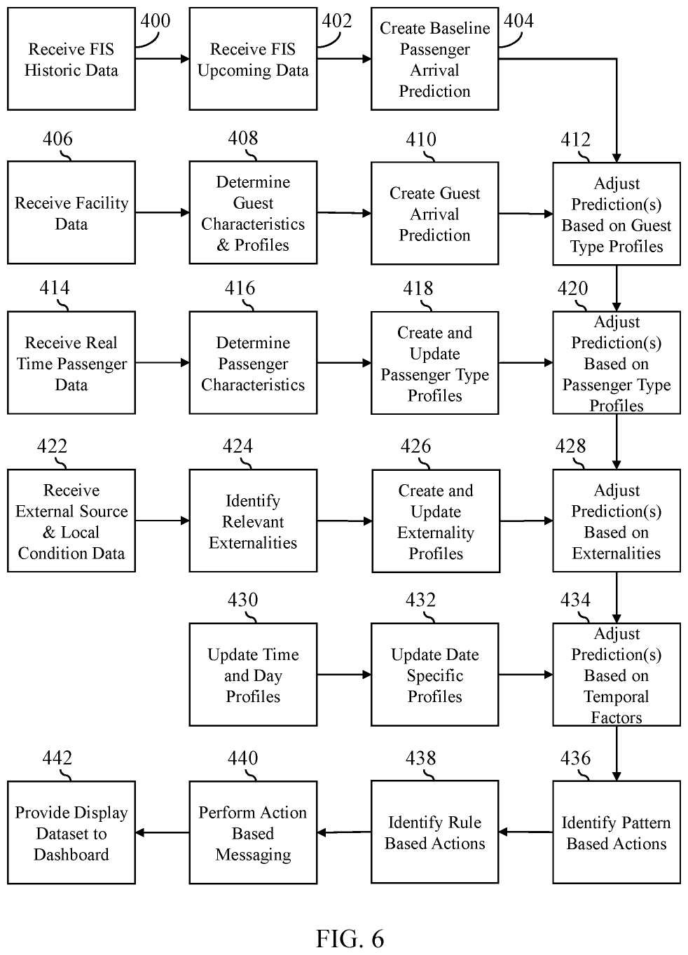

FIG. 6 is a flowchart showing steps that may be performed with the system of FIG. 1 to track and manage aspects of an airport, such as those described above. It should be understood that the steps of FIG. 6 may be performed in an ongoing manner as additional data becomes available to the system, and that some steps may be performed in parallel or independently of others. A set of historic data from the FIS may be received or accessed (400). The historic FIS data may include historic records of the numbers of boarding passes issued over periods of time, non-private data relating to boarding passes (e.g., time and date of flight, destination, and origin), numbers of boarding passes that were issued but not utilized, and other information. A set of upcoming FIS data may also be received (402) by the AMS (100), which may include the number of boarding passes issued for flights occurring over the upcoming days or weeks, non-private data relating to upcoming boarding passes, and flight schedules and status information for upcoming flights that are arriving or departing from the airport.

Based on historic and upcoming FIS data, the system may then create (404) one or more baseline predictions, including a baseline prediction for the number of passengers that will arrive at the airport over an upcoming period of time. As an example, where the upcoming FIS data indicates that boarding passes for 800 passengers have been issued for flights schedule to depart in 4 hours, and the historic FIS data indicates that passengers arrive, on average, about 2 hours before their flight, the system may determine a baseline prediction for passenger arrival that includes 800 passengers arriving in about 2 hours.

To provide additional data that may be used to adjust and/or improve upon baseline predictions, the AMS (100) may also receive (406) facility data from one or more systems, sensors, or devices in use at the airport that may indicate the arrival of guests, both passengers and non-passengers, at the airport. This may include receiving (406) information from parking systems that indicate the number of cars entering short term and/or long term parking structures, traffic sensors indicating the number of vehicles entering certain parts of the airport grounds, or traffic sensors indicating the number of pedestrians passing through doorways into the airport facility. Based on such information, the system may determine (408) characteristics and profiles for arriving guests, which may include indications that the guest is actually a passenger (e.g., a guest entering long term parking is likely a passenger), or that the guest will be waiting with a passenger for some period of time (e.g., a guest entering short term parking is likely seeing someone off, or meeting an arriving passenger).

Based on this, the system may create (410) or update a guest arrival prediction for the airport over a period of time which may include all visitors to the airport, including passengers and non-passengers. This information may also be sued to adjust (412) one or more other predictions, such as the baseline and/or modified passenger arrival prediction created (404) previously, based on the guest profiles or characteristics that have been determined. For example, a guest arriving by vehicle and driving towards a drop off point may be profiled as a transport driver, and may be associated with a variable number of passengers that will be left at the drop off point. As another example, a guest arriving and parking in a long term parking structure may be profiled as a passenger.

As an alternative or addition to other predictive processes, the system may also receive (414) real time passenger data for passengers currently on the airport grounds, such as boarding pass scan data received (414) from boarding pass scanners (106) and other sources as have been described above, which may also include sensor data that indicates the presence or flow of passengers in checkpoint queues, entry doors, and other locations of the airport. One or more passenger characteristics may be determined (416) based upon the real time data, which may include characteristics such as arrival time, flight departure time, flight destination, ticket class, seat number, and other non-private information. Passenger profiles may be created and updated based upon the characteristics of arriving passengers, which may include profiling arriving passengers based upon profile types that are relevant to arrival at the airport facility, and activities within the airport facility.

As an example, a particular passenger scan may be profiled as a business traveler based upon the destination, departure time relative to arrival time (e.g., business flyers typically do not arrive as early as others), frequent flyer status or security pre-screen status, or other factors. Such a profile is relevant as an indicator of arrival time ranges for other business flyers over upcoming time periods, and is also relevant as an indicator of resource utilization (e.g., business flyers are less likely to shop, eat at restaurants, or take advantage of other resources within the terminal).

As another example, a particular passenger scan may be profiled as a personal traveler based upon destination (e.g., an exotic destination), departure time relative to arrival time, and other factors. This profile may be relevant as an indicator of arrival time ranges for other similarly situated profiles over upcoming time periods, and is also relevant as an indicator of resource utilization (e.g., leisure flyers are more likely to shop, eat at restaurants, and take advantage of other resources within the terminal, in addition to spending lengthier times at the terminal prior to departure).

Based upon profiling of real time scans, the system may adjust (420) one or more other predictions, such as the baseline passenger arrival prediction. As an example, where a baseline prediction might indicate that 400 passengers will arrive about 2 hours from now, real time scans and other data may be used to more accurately distribute those arrivals over a period of time (e.g., a leisure flyer might arrive 3 hours before the flight instead of 2 hours, while a business flyer might arrive 1 hour before the flight). As a result, where a high number of leisure travelers are profiled for the example flight, the baseline prediction might be updated to reflect 250 passengers arriving in about 1 hour, 100 passengers arriving in about 2 hours, and 50 passengers arriving in about 3 hours. As should be appreciated, while the example above describes predictions in 1 hour increment, it should be understood that such periods are for example only, and that implementations of the described technology may predict arrival based upon varying time periods (e.g., 5 minute periods, 15 minute periods, 30 minute periods, 60 minute periods).

As an alternative or addition to other predictive processes, the system may also receive (422) external data source and local condition data, which may include weather data, local road traffic data, data relating to local events, data from ridesharing software platforms, data from mapping or device positioning software platforms, and other data suggestive of an increase or decrease of arrivals at the airport. This data may be analyzed to identify (424) one or more relevant externalities, such as current or future severe weather conditions, current or future traffic congestion, and other external characteristics that might cause particular passenger profiles to arrive earlier than normal, or be delayed beyond their typical arrival time. A set of externality profiles that describe the effects of certain externalities may be created and updated (426), and may be used to adjust (428) one or more other predictions.

As an alternative or addition to other predictive processes, the system may also update (430) and maintain a set of profiles related to the current time and day (e.g., of the week or month), that describe the effects of certain departure times, or certain departure days on passenger arrival (e.g., typical passenger arrival time may be different for a 6 AM departing flight compared to a 6 PM departing flight, or may be different for a flight departing on Saturday compared to a flight departing on Thursday). The system may also update (432) and maintain one or more date specific profiles that describe the effects of specific days on passenger arrival time (e.g., on holidays, or dates adjacent to holidays, passenger may arrive earlier or later than typical as compared to a non-holiday). The system may then update (434) one or more other predictions, such as the baseline or modified passenger predictions described above, to account for these temporal factors.

As the above described predictive datasets are created, updated, and maintained, the system may examiner the resulting datasets to identify (436) any pattern based actions that may be performed based upon detected patterns within the datasets. As an example, where a prediction that is based in part on real time scan data adjustments (420) and local condition data adjustments (428) exhibits a pattern of passenger arrival times that are delayed, resulting in a flow of several hundred passengers that typically arrives over several hours instead being compressed into a 30 minute time period, the system may identify (436) this pattern and an associated action, which may be, for example, a notification to airport personnel of the compressed arrival period, or an update to electronic messaging around the airport, or an automatic opening of additional parking facilities or security screening facilities at that time period, or other actions.

The system may also identify (438) one or more rule based actions based upon concrete characteristics of the data. Rule based actions may be based upon concrete characteristics of the data or predictions, such as a rule that is satisfied when predicted arrival volume exceeds a configured threshold for a 30 minute or 15 minute time period, or when predicted arrival volume for a 30 minute period exceeds security screening capabilities for a corresponding time period, or when real time passenger data scans exceed a configured threshold within a 15 minute period, and so on. An identified (438) rule based action to be triggered by such an event might include opening additional security screening capabilities, providing notifications to personnel of an unexpected volume of passengers, notifications to vendors or other third parties operating within the airport of the unexpected volume of passengers, or other messages.

With one or more actions identified (436, 438), the system may then perform (440) messaging tasks to complete and/or trigger the actions. Performance (440) of messaging may be implemented as an API or other direct interface with recipient systems or devices, or may be implemented as asynchronous messaging that is evaluated by a recipient system or device before any performance of an action. The system may also provide (442) a display dataset to one or more systems or devices that is configured to populate and display a dashboard or other graphical user interface that may include text and visual descriptions of predictive metrics, raw data, and any associated messaging or actions.

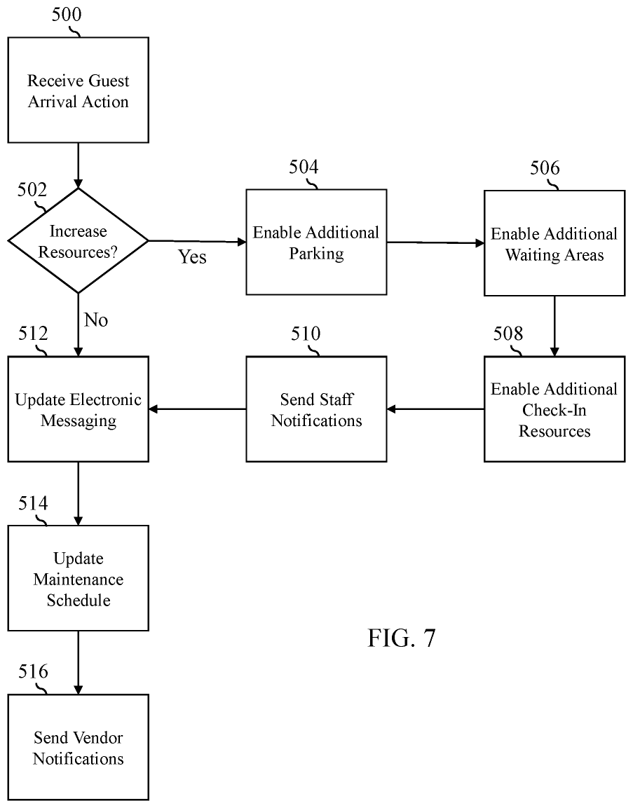

As further example of messaging actions, FIG. 7 is a flowchart showing an exemplary set of steps that may be performed to manage variances in guest arrival, such as may be performed by the AMS (100) and/or airport facility systems (114). While pattern based or rule based evaluation of received data may be associated with various data characteristics, the example of FIG. 7 relates to the volume of guest arrival at the airport relative to predicted volume, configured thresholds, or dynamic evaluation of data patterns. Where a guest arrival action is received (500) or identified, the system may first determine whether the guest arrival action is associated with a need for increased resources (502) or increased guest volume. Where the action is associated with increased resources (502) or volume, the system may provide messaging to cause one or more actions to be evaluated and performed.

As one example, the system may cause additional parking resources to be enabled (504) or otherwise modified to account for an increased volume of guests whose arrival is predicted or anticipated. This may include automatically updating electronic signage and the operation of parking gates or other features to allow entry into certain lots or areas, or to temporarily convert long term parking areas into short term parking areas, or to control the flow of incoming vehicle traffic to different areas of the airport grounds, or other changes.

As another example, this may include automatically updating electronic signage and opening or unlocking doors to enable (506) additional waiting areas, queuing areas, or other public areas within the airport grounds.

As another example, this may include automatically updating electronic signage and enabling (508) the operation of and access to additional resources relating to checking in, including check-in kiosks, baggage check kiosks, or personnel managed check-in resources.

As another example, this may include automatically sending (510) electronic messaging to mobile devices or communication networks associated with airport staff to indicate the anticipated volume of guests arriving. Such notifications may be general informational notices, or may include personnel specific instructions or tasks (e.g., “Please proceed to entrance lobby to provide assistance for high volume of guests”). Such notifications may also prompt the recipient to respond in some fashion (e.g., “Please reply with “1” to indicate you are available, or “0” to indicate you are not available”). Such responses may be received by the system (e.g., either a personnel management system or the AMS (100)) and used to aid in management of personnel or automatic reassignment of unaccepted tasks.

Other messaging actions may be of a more general nature, and may be performed in the event of any guest arrival action, including both actions indicating increased volume and decreased volume. Such actions may include updating (512) electronic messaging around the airport generally to indicate that the airport is currently operating at a higher or lower volume of guests over an upcoming time period. This may include updating websites, information provided to software applications, electronic messaging provided to recipients, and electronic displays around the airport.

Another general example may include updating (514) maintenance schedules or needs to reflect the anticipated change in guest volume. This may include increasing or decreasing the frequency at which areas are to be cleaned (e.g., restrooms, public waiting areas, walkways, parking lots) by personnel, increasing or decreasing the frequency at which public resources are to be checked, emptied, or refilled (e.g., hand sanitizer stations, garbage cans), and other actions. These changes may be implemented on a personnel management system, via notifications to affected staff, or in other ways depending upon a particular implementation.

Another general example may include sending (516) notifications to systems or devices of vendors that operate within the airport grounds (e.g., restaurants, gift shops, book stores). These vendor notifications may be informational in nature, and may simply notify vendor recipients of an expected increased or decreased volume of guests, or may be configured with a certain format or structure so that the recipient vendor system or device is able to automatically process the message and adjust vendor staffing, activities, or other resources as may be desired by the vendor.

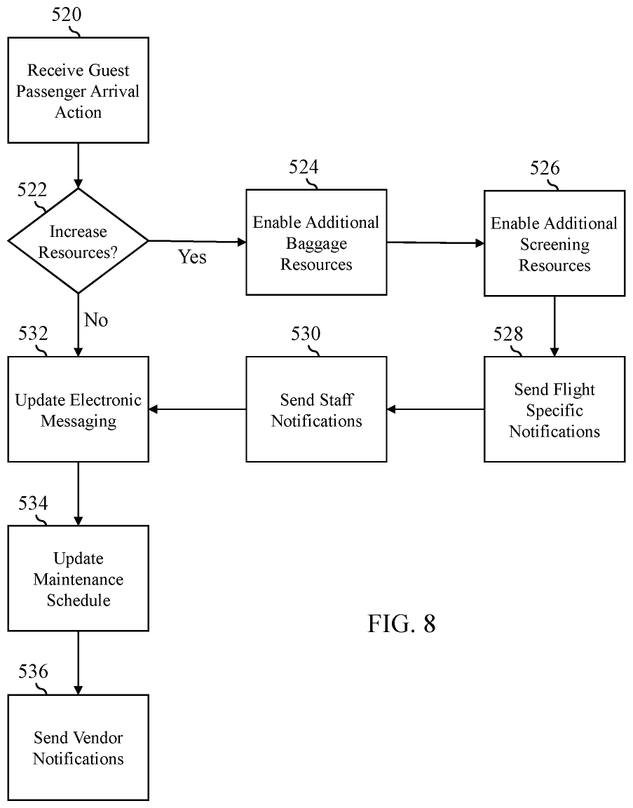

As further example of messaging actions, FIG. 8 is a flowchart showing an exemplary set of steps that may be performed to manage variances in passenger arrival, such as may be performed by the AMS (100) and/or airport facility systems (114). Similar to the example of FIG. 7 but instead focused on passengers and not just guests more generally, the example of FIG. 8 relates to the volume of passenger arrival at the airport relative to predicted volume, configured thresholds, or dynamic evaluation of data patterns. While guest related actions may apply to the airport grounds as a whole, passenger related actions may be more specific to certain areas of the airport, or to certain flights, as only passengers will enter secure areas of the airport or board a plane, while non-passenger guests will be confined to public areas. Where a passenger arrival action is received (520) or identified, the system may first determine whether the guest arrival action is associated with a need for increased resources (522) or increased passenger volume. Where the action is associated with increased resources (522) or volume, the system may provide messaging to cause one or more actions to be evaluated and performed. This may include enabling (524) additional resources specific to the intake and management of passenger checked baggage (e.g., via notifications, updates to personnel management system, or both).

As another example, this may include enabling (526) additional security screening resources at security checkpoints throughout the airport that passengers must pass through. This may include updating electronic messaging around security screening areas, enabling automated screening devices, and/or providing notifications to screening personnel with instructions to open additional resources, reconfiguring queuing lanes, or otherwise.

As another example, this may include sending (528) flight specific notifications to systems or devices. Flight specific notifications may include notices that certain flights will have a high volume of passengers arriving in upcoming time periods, which may be provided to flight related systems or personnel, or may also be provided to passengers who have registered for electronic notification.

As another example, this may include sending (530) electronic messaging to mobile devices or communication networks associated with airport staff to indicate the anticipated volume of passengers arriving. Such notifications may be general informational notices, or may include personnel specific instructions or tasks (e.g., “Please proceed to security screening area and open additional queuing lanes”, “Please proceed to Gate A26 to assist with high boarding volume over next 30 minutes”). Such notifications may also prompt the recipient to respond in some fashion (e.g., “Please reply with “1” to indicate you are available, or “0” to indicate you are not available”). Such responses may be received by the system (e.g., either a personnel management system or the AMS (100)) and used to aid in management of personnel or automatic reassignment of unaccepted tasks.

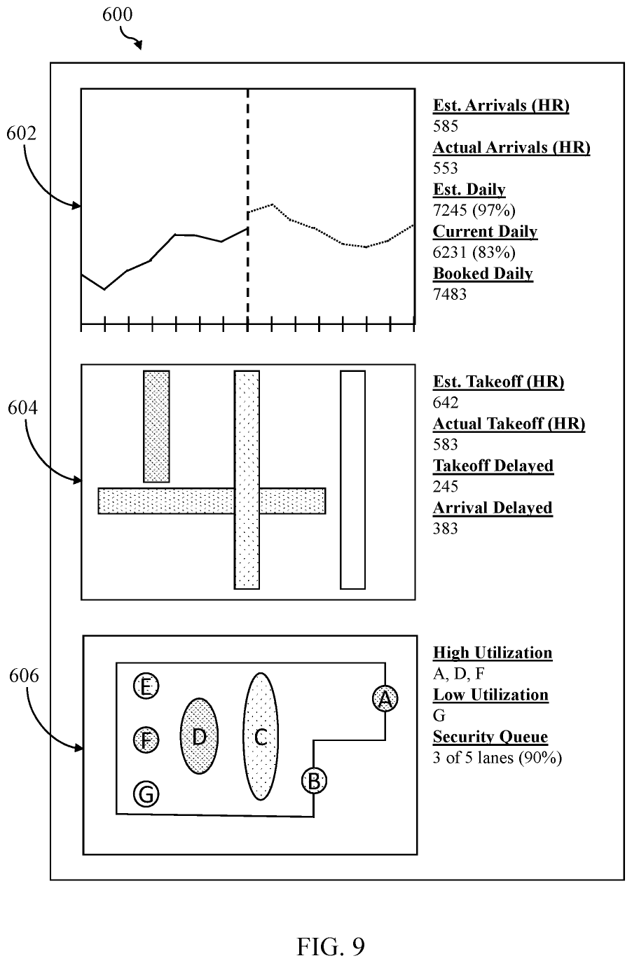

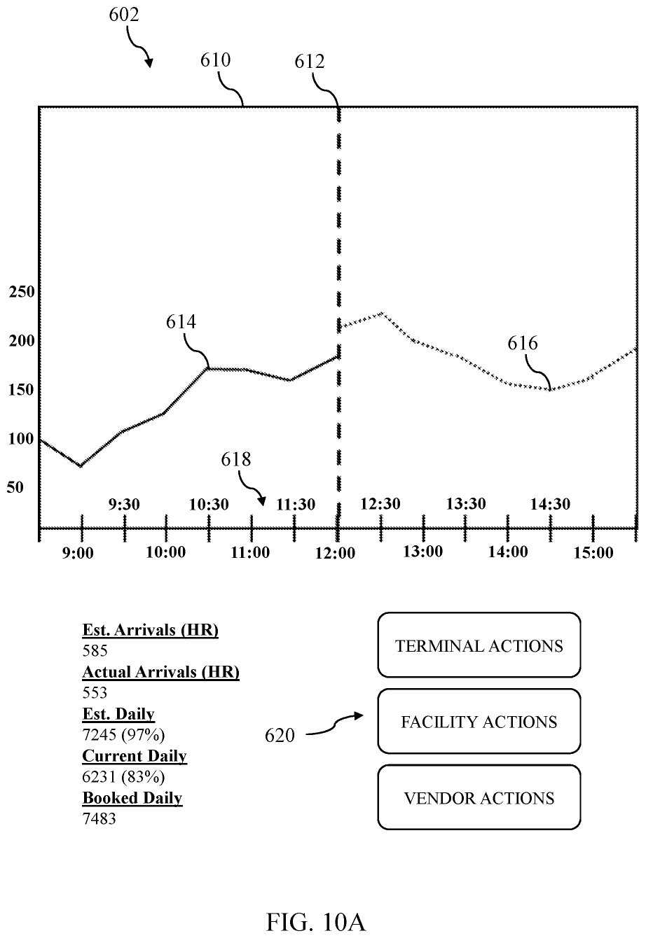

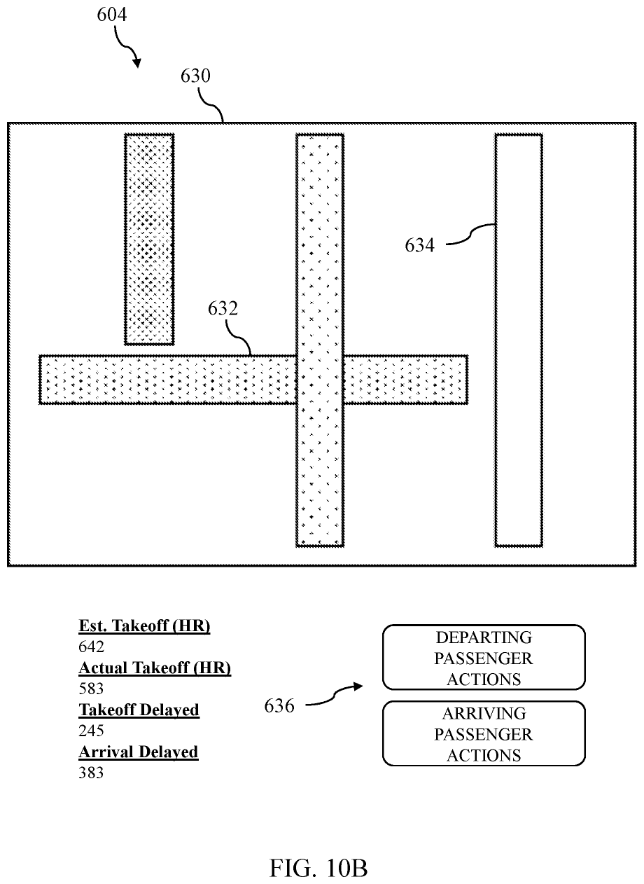

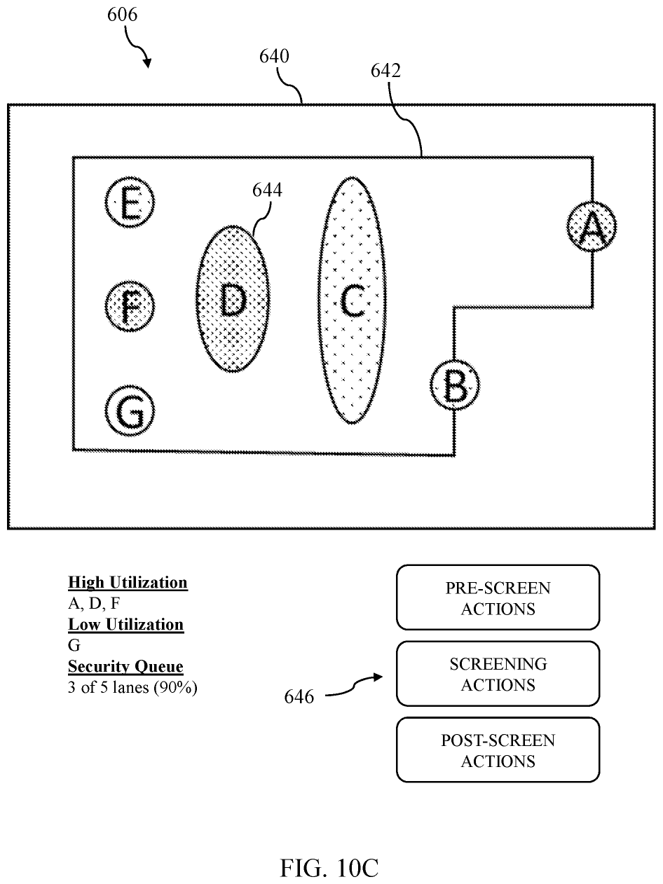

As an example of a dashboard or user interface provided by the system, FIG. 9 shows a screenshot of an exemplary management interface or dashboard (600). The management interface or dashboard (600) may be displayed by a web browser or other software application based upon data provided by the AMS (100) (e.g., via the external messaging and dashboard interface (118)). The management interface includes an arrival timeline (602), a runway heat map (604), and a facility heat map (606), each of which are described in FIGS. 10A-10C.

FIG. 10A shows the arrival timeline (602), which may show information as a continuously updating timeline (610) or other visualization of actual arrival of guests, passengers, or both (614), along with future predicted arrival of guests, passengers, or both (616), as well as related information (e.g., estimated arrivals in next hour, actual arrivals in previous hour, estimated daily total arrivals, current daily arrivals so far, and total daily booked flights). Information to the left of a divider (612), associated with the current time, reflects actual arrival data (614), while information to the right of the divider (612) reflects predicted arrival data (616) (e.g., such as described in the context of FIG. 6). The shown data may be updated in real time based upon changes in the actual/historic data available (e.g., real time passenger data (120), historic passenger data (122)), and the predictive data (616) may also be updated in real time based upon changes in external data (124), facility data (126), or data from other sources.

The data is displayed based upon a time increment (618) which may be, for example, between about 5 minutes and about 60 minutes, and in particular may be advantageous when configured as about 15 minutes or about 30 minutes. With 14 total increments (e.g., 7 to the left of the divider (612) and 7 to the right) the timeline (602) shows 7 past time periods (e.g., totaling between about 2 hours and about 6 hours) and 7 future time periods, with the time periods updating (e.g., a previous future time period becomes a current/past time period as time elapses and it moves to the right of the divider (612)) based upon the passage of time. In some implementations, the predicted volume (616) data may be displayed to the left of the divider (612) to provide a comparison of the accuracy of the predicted volume (616) to the actual observed volume (614).

The timeline interface (602) may also include a set of controls (620) that may be interacted with to manually select certain actions or messaging to be provided by the AMS (100), or to confirm automatically identified actions. The particular actions available via the controls (620) will vary by implementation, but may include terminal actions (e.g., electronic notifications, messaging, or automated actions relating to a terminal portion of the airport), facility actions (e.g., electronic notifications, messaging, or automated actions relating to non-terminal portions of the airport, such as parking, roadways, or walking paths), and vendor actions (e.g., electronic notifications, messaging, or automated actions relating to vendors operating on airport grounds).

FIG. 10B shows the runway heatmap (604), which may show information related to current or future activity on runways at the airport as a heat map visualization (630) of those runways (632, 634), with a pattern, color, or other visual characteristic indicating activity on a particular runway. For example, a first runway (632) is displayed with a dense dotted pattern, indicating high activity, while a second runway (634) is displayed with no pattern, indicating that it is not in use during upcoming time periods. The heatmap (630) may also displayed with related information (e.g., estimated passengers departing over the next hour, actual passengers departing over the prior hour, number of passengers whose departure is currently delayed, and number of passengers whose arrival at the airport is currently delayed). Such information may be displayed as an aggregate, or may be specific to a particular runway if a user clicks on or hovers over a runway visualization (632, 634). The heatmap (630) may also include a set of controls (636) that a user may interact with to manually select certain actions or messaging, or to confirm automatically identified actions. The particular actions available via the controls (636) will vary by implementation, but may include departing passenger actions (e.g., notifications to passengers currently waiting to depart, or messaging to personnel and systems related to departing passengers), and arriving passenger actions (e.g., notifications to passengers that will soon be arriving at the airport, or messaging to personnel and systems related to arriving passengers).

FIG. 10C shows the facility heatmap (606), which includes a heatmap (640) that shows a visualization of buildings (642) (e.g., the terminal, but may also display related buildings, nearby facilities, parking, etc.). The heatmap (640) includes activity zones labeled A-G, which may be positioned on the visualization (642) at corresponding locations, and may be presented with visual characteristics (e.g., color, size, shape, patterns, etc.) indicating activity at those locations. In the shown example, zones A and B may correspond to different entrances to the terminal, while zone C may correspond to a lobby or public area within the terminal. Zone D (644) may correspond to a security checkpoint beyond zone C, which gives access to different departure gate areas E, F, and G. In FIG. 10C, zone D is displayed with a dense dotted pattern, which may indicate high traffic, crowds, or utilization of available resources at that location.

The facility heatmap (606) may also include information relating to the heatmap, which may relate to the entire facility or may be focused on particular areas (e.g., by configuration, or based upon a user clicking or hovering over a particular area). Displayed information may include, for example, areas that have high utilization currently, areas that currently have low utilization, and specific resources in use at particular areas (e.g., an indication that the security queue has 5 total lanes, 3 of which are currently operating at 90% capacity). A set of controls (646) may also be included that a user may interact with to manually select certain actions or messaging, or to confirm automatically identified actions. The particular actions available via the controls (646) will vary by implementation, but may include pre-screening actions (e.g., actions or messaging related to areas prior to a security checkpoint, such as A, B, and C), screening actions (e.g., actions or messaging related to the screening area zone D (644)), and post-screening actions (e.g., actions or messaging related to the post-screen zones E, F, and G).

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

1. A system for predicting passenger arrival at an airport facility comprising:
(a) an airport management server comprising a processor, wherein the airport management server is in uni-directional communication with a flight information system and configured to receive a flight information dataset from the flight information system, wherein the flight information dataset comprises an upcoming flight dataset for a subsequent period of time that is based on issued boarding passes for the subsequent period of time, and a historic flight dataset for a previous period of time based on utilized boarding passes during the previous period of time;
(b) a redaction interface comprising software instructions for modifying information received from a boarding pass based upon a pre-configured filter, wherein the pre-configured filter identifies a plurality of personally identifiable data fields that are removed to produce a redacted dataset that includes at least a flight identifier;
(c) a boarding pass scanner configured to scan and receive information from the boarding pass, wherein the boarding pass scanner is positioned within an arrival area of the airport facility and is communicatively coupled to the airport management server via the redaction interface;
wherein the processor is configured to:
(i) receive a plurality of redacted datasets from the redaction interface in response to a plurality of passengers scanning boarding passes in the arrival area, and associate each of the plurality of redacted datasets with one of a plurality of flight identifiers described in the historic flight dataset;
(ii) create a plurality of passenger profiles based upon the association between the plurality of redacted datasets and the historic flight dataset, wherein each passenger profile describes a pre-flight arrival time that passengers associated with characteristics of that passenger profile will arrive at prior to that passenger's flight and, for each passenger of the upcoming flight dataset, associate a passenger profile of the plurality of passenger profiles with that passenger based upon that passenger having characteristics of that passenger profile;
(iii) for the subsequent period of time, determine a time-indexed volume of passenger arrival at the airport facility based on the pre-flight arrival time and actual flight time for each passenger; and
(iv) display a management dashboard on a display of a user device based on the time-indexed volume of passenger arrival.

2. The system of claim 1, wherein the management dashboard comprises an arrival timeline that comprises:
(a) a plurality of past time intervals and, for each past time interval, an indication of actual passenger arrival; and
(b) a plurality of subsequent time intervals and, for each subsequent time interval, an indication of predicted passenger arrival based on the time-indexed volume of passenger arrival.

3. The system of claim 2, wherein the arrival timeline comprises a visual indication of a current time interval that separates the indication of actual passenger arrival and the indication of predicted passenger arrival.

4. The system of claim 2, wherein the arrival timeline comprises:
(a) a description of total actual daily bookings based on the upcoming flight dataset;
(b) a description of total estimated daily bookings that will be utilized based on the time-indexed volume of passenger arrival, relative to the total actual daily bookings; and
(c) a description of total estimated passenger arrival over the plurality of past time intervals, relative to the total actual daily bookings.

5. The system of claim 1, wherein the management dashboard comprises a runway heatmap that comprises:
(a) a visualization of one or more runways at the airport facility; and
(b) a set of visual characteristics associated with the visualization of one or more runways based on the time-indexed volume of passenger arrival, wherein the set of visual characteristics indicate a volume of passengers leaving the airport facility via each of the one or more runways.

6. The system of claim 1, wherein the management dashboard comprises a facility heatmap that comprises:
(a) a visualization of one or more activity zones within the airport facility through which arriving passengers move;
(b) a set of visual characteristics associated with the visualization of one or more activity zones based on the time-indexed volume of passenger arrival, wherein the set of visual characteristics indicate a volume of passengers within each activity zone.

7. The system of claim 1, further comprising a redaction device communicatively coupled to the boarding pass scanner and configured to provide the redaction interface between the boarding pass scanner and the airport management server.

8. The system of claim 7, wherein the redaction device is configured to prevent any portion of information received from the boarding pass from being stored by the redaction device after providing the redacted dataset to the airport management server.

9. The system of claim 7, wherein the redaction device is configured to only store any portion of information received from the boarding pass in volatile memory, such that the information is destroyed if the redaction device loses power.

10. The system of claim 1, wherein the redacted dataset comprises three or more of:
(a) the flight identifier;
(b) a flight destination;
(c) a flight departure time;
(d) a seat number; and
(e) a seat zone.

11. The system of claim 1, wherein the processor is further configured to:
(a) receive a facility dataset from one or more other systems, sensors, or devices operating at the airport facility, wherein the facility dataset describes a volume of guest arrivals at the airport facility;
(b) determine an estimated number of passenger arrivals within the volume of guest arrivals based on the plurality of passenger profiles; and
(c) determine the time-indexed volume of passenger arrival based on the pre-flight arrival times and actual flight times for each passenger, and further on the estimated number of passenger arrivals within the volume of guest arrivals.

12. The system of claim 1, wherein the processor is further configured to:
(a) receive a local condition dataset, wherein the local condition dataset describes one or more external conditions associated with an impact on traveling to the airport facility;
(b) determine the time-indexed volume of passenger arrival based on the pre-flight arrival times and actual flight times for each passenger, and further on the one or more external conditions from the local condition dataset.

13. The system of claim 1, wherein the processor is further configured to:
(a) for each flight described in the upcoming flight dataset, determine a time and a date of the flight, and whether a temporal factor applies based on the time and the date, wherein the temporal factor is associated with an increase or a decrease of the pre-flight arrival time for passengers on that flight; and
(b) determine the time-indexed volume of passenger arrival at the airport facility based on the modified pre-flight arrival time and actual flight time for each passenger.

14. The system of claim 1, wherein the processor is further configured to:
(a) for each time period of a plurality of time periods within the time-indexed volume of passenger arrival, determine whether the passenger arrival for that time period exceeds a pre-configured threshold for passenger arrival; and
(b) where the pre-configured threshold for passenger arrival is exceeded, automatically update the configurations of one or more electronic signage devices to cause those one or more electronic signage devices to display an alternate message.
